(19) United States
(12) Patent Application Publication
(10) Pub. No.: US 2010/0276614 A1
(43) Pub. Date: Nov. 4, 2010

(54) MODULAR IN-LINE FLUID REGULATORS

(76) Inventors: Daryll Duane Patterson, Brooklyn Park, MN (US); Jason Dirk Jablonski, Zimmerman, MN (US)

Correspondence Address: HANLEY, FLIGHT & ZIMMERMAN, LLC, 150 S. WACKER DRIVE, SUITE 2100, CHICAGO, IL, 60606, US

(21) Appl. No.: 12/835,580

(22) Filed: Jul. 13, 2010

Related U.S. Application Data
(63) Continuation of application No. 11/855,830, filed on Sep. 14, 2007.

(51) Int. Cl. F16K 31/12

(52) U.S. Cl. 251/12

(57) ABSTRACT

Modular in-line fluid regulators are described. An example fluid regulator apparatus includes a fluid regulator comprising a body defining a fluid inlet port and a fluid outlet. The fluid inlet port is configured to interchangeably receive a coupling associated with one-stage fluid regulation or a modular in-line fluid regulator associated with two-stage fluid regulation. The modular in-line fluid regulator is configured to be positioned substantially within the fluid inlet port to change the fluid regulator apparatus from a one-stage fluid regulator to a two-stage fluid regulator. The fluid regulator apparatus includes a diaphragm operatively coupled to a valve assembly to control a flow of fluid through the valve assembly based on a pressure of the fluid outlet.

### RELATED APPLICATION

This patent arises from a continuation of U.S. application Ser. No. 11/855,830 filed Sep. 14, 2007, which is hereby incorporated herein by reference in its entirety.

### FIELD OF THE DISCLOSURE

The present disclosure relates generally to fluid regulators and, more particularly, to modular in-line fluid regulators.

### BACKGROUND

Process control systems utilize a variety of field devices to control process parameters. Fluid regulators are commonly distributed throughout process control systems to control the pressures of various fluids (e.g., liquids, gasses, etc.). Fluid regulators are typically used to regulate the pressure of a fluid to a substantially constant value. Specifically, a fluid regulator has an inlet that typically receives a supply fluid at a relatively high pressure, which may vary or fluctuate, and provides a relatively lower and substantially constant pressure at an outlet. For example, a gas regulator associated with a piece of equipment may receive a gas having a relatively high pressure from a gas distribution source and may regulate the gas to have a lower, substantially constant pressure suitable for safe, efficient use by the equipment.

Fluid regulators typically control the flow and pressure of fluid using a diaphragm or piston having a set or control pressure force applied to one of its sides via a bias spring. The diaphragm or piston is also operatively coupled directly or via a linkage to a valve component that is moved relative to an orifice of a seat that fluidly couples the inlet of the regulator to its outlet. The diaphragm or piston moves the valve component in response to a difference between the outlet pressure and the set or control pressure to vary the flow through the regulator to achieve a substantially constant outlet pressure, which provides a balancing force to the other side of the diaphragm or piston that is equal or proportional to the set or control pressure.

Fluid regulators may be configured as single-stage or one-stage systems in which only one regulating valve and associated components are fluidly interposed between an inlet pressure and a regulated outlet pressure. However, such single-stage or one-stage systems may exhibit significant changes in output pressure in response to changes in the inlet or supply pressure. For example, in some applications, such as those involving regulation of a fluid provided via a high-pressure gas bottle, inlet pressure at the regulator can vary by a factor of six or more, which can cause significant variation in the regulated output pressure provided by a single-stage regulator.

Multi-stage (e.g., two-stage) fluid regulators can provide substantially reduced output pressure variation in response to inlet pressure variations such as those noted above. For example, in comparison to a one-stage fluid regulator, a two-stage fluid regulator may provide a five-fold reduction in output pressure variation in response to an inlet pressure variation. However, in practice, two-stage fluid regulator systems are often implemented after a one-stage system fails to provide a desired level of performance (e.g., a desired maximum output pressure variation). As a result, a second, bulky fluid regulator may be field installed in series with the original, underperforming fluid regulator to achieve the desired overall performance. Alternatively, the original, underperforming fluid regulator may be removed and replaced with another two-stage fluid regulator assembly. In either case, such field-based retrofit or re-installation can be very time consuming, costly, and may result in a regulator system that consumes significantly more valuable space (e.g., control cabinet space) in the process control environment.

### SUMMARY

An example fluid regulator apparatus includes a fluid regulator comprising a body defining a fluid inlet port and a fluid outlet. The fluid inlet port is configured to interchangeably receive a coupling associated with one-stage fluid regulation or a modular in-line fluid regulator associated with two-stage fluid regulation. The modular in-line fluid regulator is configured to be positioned substantially within the fluid inlet port to change the fluid regulator apparatus from a one-stage fluid regulator to a two-stage fluid regulator. The fluid regulator apparatus includes a diaphragm operatively coupled to a valve assembly to control a flow of fluid through the valve assembly based on a pressure of the fluid outlet.

An example fluid regulator apparatus includes a fluid regulator comprising a body defining a fluid inlet port and a fluid outlet. The fluid inlet port is configured to interchangeably receive a coupling associated with one-stage fluid regulation or a modular in-line fluid regulator associated with two-stage fluid regulation. The modular in-line fluid regulator includes a valve plug, a valve seat to be engaged by the valve plug and a pressure sensing member operatively coupled to the valve plug to control a position of the valve plug relative to the valve seat. When the modular in-line fluid regulator is received by the fluid inlet port, the fluid regulator apparatus changes from a one-stage fluid regulator to a two-stage fluid regulator without substantially changing a size of the fluid regulator.

An example method of field converting a fluid regulator apparatus from a one-stage fluid regulator to a multi-stage fluid regulator includes removing a coupling associated with one-stage fluid regulation from an inlet port of a fluid regulator. The inlet port being configured to interchangeably receive the coupling or a modular in-line fluid regulator associated with multi-stage fluid regulation. The method includes inserting the modular in-line fluid regulator into the inlet port to change the fluid regulator apparatus from a one-stage fluid regulator to a multi-stage fluid regulator without substantially changing a size of the fluid regulator.

### BRIEF DESCRIPTION OF THE DRAWINGS

FIG. 1 depicts a known in-line fluid regulator configuration.

FIG. 2 depicts an example two-stage fluid regulator system or assembly having a modular in-line fluid regulator installed in an adjustable regulator.

FIG. 3 depicts another example modular in-line fluid regulator.

FIG. 4 depicts the example modular in-line fluid regulator of FIG. 3 installed on a known adjustable regulator.

### DETAILED DESCRIPTION

The example modular in-line fluid regulators described herein can be easily installed in another fluid regulator to form a multi-stage (e.g., two-stage) fluid regulator having excellent regulation characteristics, which minimize the effect of supply or inlet pressure changes on output or outlet pressure. More specifically, in some implementations, the example modular in-line fluid regulators may be installed in the body of another fluid regulator (e.g., a primary adjustable regulator) to form a first stage fluid regulator that is fluidly coupled to the other fluid regulator, which then functions as a second-stage regulator. The other regulator (e.g., the primary adjustable fluid regulator) may include a threaded opening into which the modular in-line fluid regulator is inserted and threadably engaged. Once engaged to the other fluid regulator, the modular in-line fluid regulator may function as a first-stage regulator for the other fluid regulator to enable the other fluid regulator to provide improved output regulation characteristics.

In other implementations, the example modular in-line fluid regulators may be provided in a casing or housing having an inlet and an outlet. The outlet may be formed in a threaded protrusion or fitting that is configured to be threadably engaged to a threaded inlet opening of a conventional fluid regulator (e.g., an adjustable fluid regulator). In these implementations, the modular in-line fluid regulators may have a cartridge-like appearance and geometry. Further, similar to the implementations noted above in which the modular in-line fluid regulator is inserted into a threaded opening of another regulator body, these other implementations may use the modular fluid regulator as a first-stage fluid regulator to the other fluid regulator, which then functions as a second-stage fluid regulator.

More generally, the example modular in-line fluid regulators described herein can be factory installed as an option to provide a relatively compact two-stage fluid regulator system. Alternatively, the example modular in-line fluid regulators described herein can be easily field retrofitted or installed in another fluid regulator to convert a one-stage regulation system to a relatively compact two-stage regulation system.

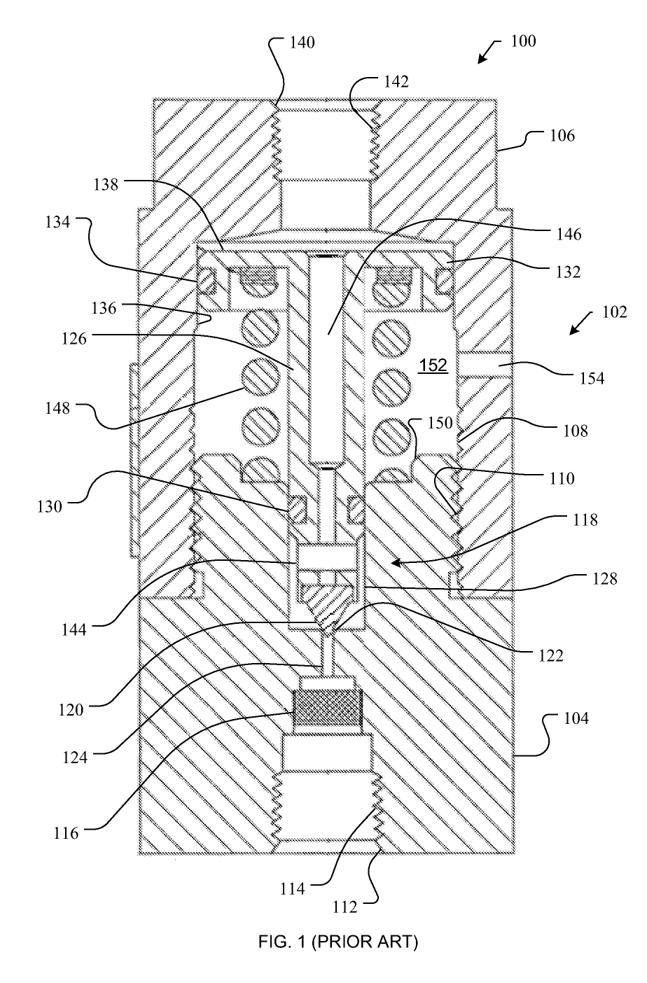

FIG. 1 depicts a cross-sectional view of a known in-line one-stage fluid regulator 100. The known fluid regulator 100 has generally cylindrical body, housing, or casing 102 including a lower casing or first portion 104 and an upper casing, bonnet, or second portion 106. The first and second portions 104 and 106 are threadably engaged via respective mating threads 108 and 110. The first portion 104 includes an inlet port 112 having internal threads 114 to engage a pipe or other fluid carrying conduit. Additionally, a filter or screen 116 is provided in the inlet 112 to prevent dirt and/or other debris from contaminating the regulator and impairing its operation. The first portion 104 also holds or guides a valve assembly 118. The valve assembly 118 includes a fluid flow control member or plug 120 that moves relative to an opening or orifice 122 of a passage 124, which is fluidly coupled to the inlet 112, to control the flow of fluid into the regulator 100. The fluid flow control member or plug 120 is fixed to a stem 126 that is slidably engaged with a bore 128 in the first housing portion 104. An o-ring 130 forms a circumferential seal between the wall of the bore 128 and the stem 126. The stem 126 is integrally formed with a piston 132 that is slidably engaged within the upper or second casing portion 106. An o-ring 134 provides a seal against an inner wall 136 of the upper or second casing portion 106. An upper surface 138 of the piston 132 is fluidly coupled to an outlet pressure port 140, which includes internal threads 142 for receiving a pipe or other fluid conduit.

As can been seen clearly in FIG. 1, the bore 128 is fluidly coupled to the outlet port 140 via passageways 144 and 146. Thus, when the plug 120 is spaced from the orifice 122, fluid can flow from the inlet 112 to the outlet 140 to increase the pressure at the outlet 140. A compression spring 148 is disposed between the piston 132 and a seat 150 of the first or lower casing portion 104. A chamber 152 between the piston 132 and the seat 150 is vented via an opening 154 to the atmosphere and, thus, remains at atmospheric pressure during operation of the regulator 100.

In operation, the spring 148 biases or urges the piston 132 and, thus, the plug 120 away from the orifice 122 so that the valve 118 provides a normally-open configuration. Thus, in the absence of a pressure greater than atmospheric pressure at the outlet 140, the valve 118 is in a fully open condition. Further, as the inlet 112 passes pressurized fluid to the outlet 140, the pressure at the outlet 140 increases and the pressure on the surface 138 of the piston 132 increases and urges the plug 120 toward the orifice 122, thereby restricting the flow of fluid from the inlet 112 to the outlet 140. When the pressure at the outlet 140 is sufficiently high, a force balance condition (i.e., the pressure exerted by the spring will balance against the pressure at the outlet 140) will be achieved so that the pressure at the outlet 140 is at a substantially constant pressure lower than the pressure at the inlet 112. The force balance-based operation of such fluid regulators is well known and, thus, is not described in greater detail herein.

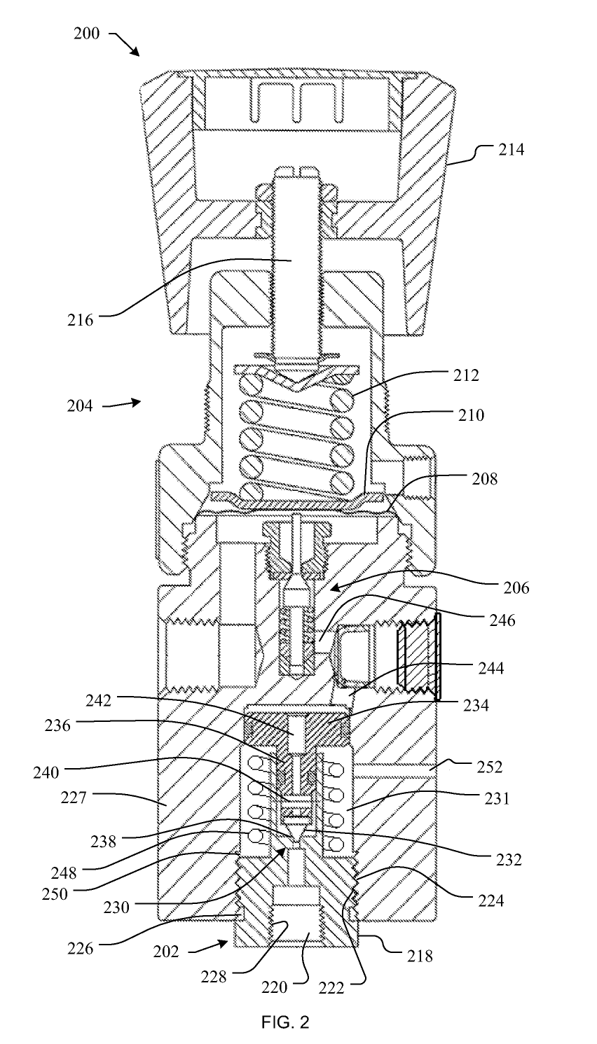

FIG. 2 depicts an example two-stage fluid regulator system or assembly 200 having a modular in-line fluid regulator 202 installed in an adjustable regulator 204. In the example of FIG. 2, the modular in-line fluid regulator 202 functions as a first-stage in-line fluid regulator and the adjustable fluid regulator 204 functions as a second-stage in-line fluid regulator, which is serially fluidly coupled to the modular in-line fluid regulator 202. The adjustable fluid regulator 204 includes a valve assembly 206 that is operatively coupled to a diaphragm 208, a spring plate 210, and a spring 212, all of which cooperate in a conventional manner to control the fluid flowing through the valve assembly 206. Additionally, the regulated output pressure of the adjustable fluid regulator 204 may be set or adjusted via a manually operable adjuster or knob 214 that, when rotated, causes a threaded rod 216 to change the compression of the spring 212.

The modular in-line fluid regulator 202 includes a body 218 having an inlet 220 and a threaded outer surface 222 that engages a threaded inner surface 224 of an opening 226 in a body 227 of the adjustable fluid regulator 204. The threaded inner surface 224 may be sized and configured to receive the threaded outer surface 222 of the body 218 or, alternatively, a threaded coupling, fitting, or the like to directly couple a pressure supply conduit or line. Similarly, the inlet 220 may include an internally threaded surface 228 to receive a threaded coupling, fitting, etc. to couple a pressure supply conduit or line to the modular in-line fluid regulator 202. The modular in-line fluid regulator 202 includes a valve assembly 230 disposed in a cavity 231 and having a plug 232 coupled to a pressure sensing member or piston 234 via a stem 236. The valve assembly 230 operates in a conventional manner to control the flow of fluid from the inlet 220, through an orifice 238 and passageways 240, 242, and 244 to an inlet 246 of the valve 204. A spring 248 is disposed between the piston 234 and a spring seat 250 of the body 218. The spring 248 may be sized and configured to provide a desired regulated pressure at the outlet passage 242 of the regulator 202. Additionally, the cavity 231 may be vented to atmospheric pressure via a passageway 252.

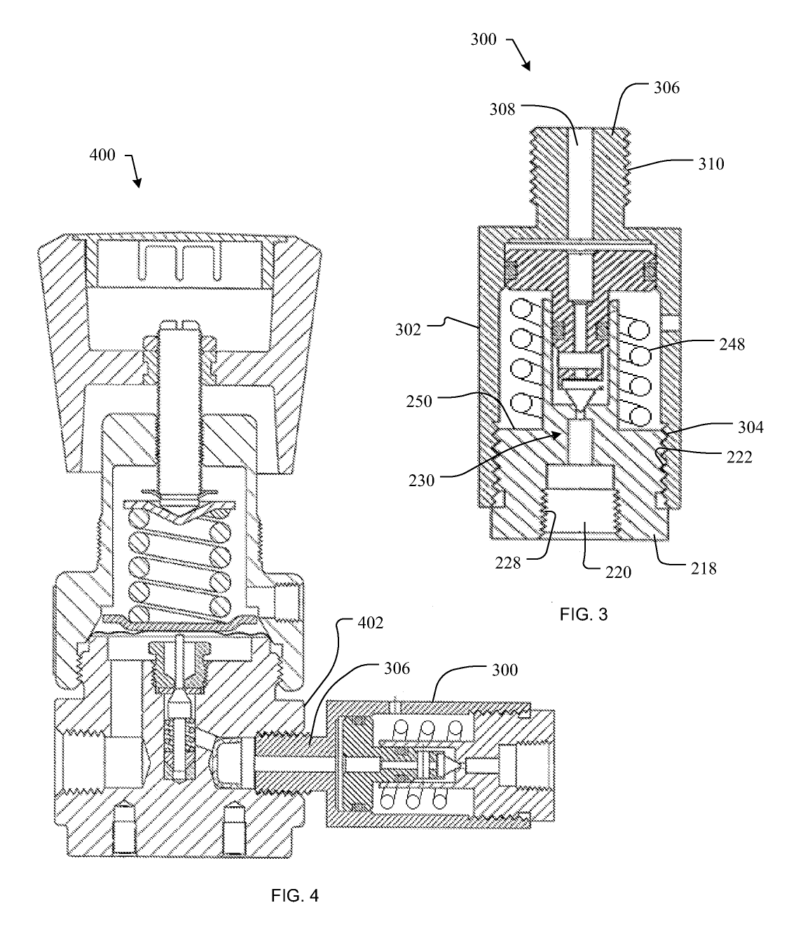

FIG. 3 depicts another example modular in-line fluid regulator 300. The example regulator 300 may be implemented using many components similar or identical to those used to implement the example regulator 202 depicted in FIG. 2. Those similar or identical components are labeled with the same reference numbers used in connection with FIG. 2. Unlike the example modular in-line fluid regulator 202 depicted in FIG. 2, the example modular in-line fluid regulator 300 of FIG. 3 includes an outer body, casing or housing 302 having threads 304 to threadably engage the body 218. Additionally, the outer body, casing, or housing 302 includes a fitting or protrusion 306 having an outlet passage 308 and an externally threaded surface 310.

FIG. 4 depicts the example modular in-line fluid regulator 300 of FIG. 3 installed on a known adjustable regulator 400. As depicted in FIG. 4, the fitting 306 of the example in-line fluid regulator 300 is threadably engaged to an inlet 402 of the fluid regulator 400 so that the modular in-line fluid regulator 300 forms a non-adjustable first-stage fluid pressure regulator and the adjustable regulator 400 functions as a second-stage fluid regulator.

The example modular in-line fluid regulators 202 and 300 described herein can be advantageously used to easily and quickly install another stage of regulation in or on another fluid regulator that has already been field installed. For example, in the case where an existing fluid regulator fails to provide a desired output pressure regulation performance, the example modular in-line fluid regulators 202 and 300 described herein can be installed by removing any inlet fittings from the inlet of the existing fluid regulator, threadably coupling one of the modular in-line fluid regulators 202 and 300 to the inlet of the existing fluid regulator and then coupling the inlet fitting(s) to the inlet of the newly installed modular in-line fluid regulator.

While the example modular in-line fluid regulators 202 and 300 described herein are depicted as being generally cylindrically-shaped, any other shape(s) could be used instead. For example, the casings or bodies used may have a polygonal (e.g., rectangular) cross-section. Additionally, while the example modular in-line fluid regulators described herein are depicted as being fluidly coupled to the inlets of other valves and as using piston operated valves, these example in-line fluid regulators could instead be coupled to a control pressure output or outlet of another fluid regulators and/or diaphragm operated valves could be used instead.

Although certain methods, apparatus, and articles of manufacture have been described herein, the scope of coverage of this patent is not limited thereto. To the contrary, this patent covers all methods, apparatus, and articles of manufacture fairly falling within the scope of the appended claims either literally or under the doctrine of equivalents.

What is claimed is:

1. A fluid regulator apparatus, comprising:
a fluid regulator comprising a body defining a fluid inlet port and a fluid outlet, wherein the fluid inlet port is configured to interchangeably receive a coupling associated with one-stage fluid regulation or a modular in-line fluid regulator associated with two-stage fluid regulation, wherein the modular in-line fluid regulator is configured to be positioned substantially within the fluid inlet port to change the fluid regulator apparatus from a one-stage fluid regulator to a two-stage fluid regulator; and
a diaphragm operatively coupled to a valve assembly to control a flow of fluid through the valve assembly based on a pressure of the fluid outlet.

2. The fluid regulator apparatus of claim 1, wherein the fluid inlet port comprises a threaded portion to be threadably engaged by the modular in-line fluid regulator.

3. The fluid regulator apparatus of claim 1, wherein the fluid inlet port comprises a cavity to receive a majority of the modular in-line fluid regulator.

4. The fluid regulator apparatus of claim 1, wherein the modular in-line fluid regulator comprises:
a valve plug;
a valve seat to be engaged by the valve plug; and
a pressure sensing member operatively coupled to the valve plug to control a position of the valve plug relative to the valve seat.

5. The fluid regulator apparatus of claim 4, wherein the pressure sensing member is to slidably engage a surface of the fluid inlet port.

6. The fluid regulator apparatus of claim 4, wherein the modular in-line fluid regulator further comprises a biasing element to bias the pressure sensing member.

7. The fluid regulator apparatus of claim 4, wherein the pressure sensing member comprises a piston.

8. The fluid regulator apparatus of claim 4, wherein the modular in-line fluid regulator comprises a guide that receives at least a portion of a stem coupled to the pressure sensing member, the guide to at least partially guide movement of the pressure sensing member.

9. The fluid regulator apparatus of claim 1, wherein the two-stage fluid regulator comprises an in-line two-stage fluid regulator.

10. The fluid regulator apparatus of claim 1, wherein the fluid inlet port defines a passageway to vent a portion of the fluid inlet port to atmospheric pressure when the fluid inlet port receives the modular in-line fluid regulator.

11. A fluid regulator apparatus, comprising:
a fluid regulator comprising a body defining a fluid inlet port and a fluid outlet, wherein the fluid inlet port is configured to interchangeably receive a coupling associated with one-stage fluid regulation or a modular in-line fluid regulator associated with two-stage fluid regulation, the modular in-line fluid regulator, comprising:
a valve plug;
a valve seat to be engaged by the valve plug; and
a pressure sensing member operatively coupled to the valve plug to control a position of the valve plug relative to the valve seat, wherein, when the modular in-line fluid regulator is received by the fluid inlet port, the fluid regulator apparatus changes from a one-stage fluid regulator to a two-stage fluid regulator without substantially changing a size of the fluid regulator.

12. The fluid regulator apparatus of claim 11, wherein the fluid inlet port comprises a threaded portion to be threadably engaged by the modular in-line fluid regulator.

13. The fluid regulator apparatus of claim 11, wherein the pressure sensing member defines a passageway to enable fluid flow therethrough.

14. The fluid regulator apparatus of claim 11, wherein the pressure sensing member is to slidably engage a surface of the fluid inlet port.

15. The fluid regulator apparatus of claim 11, wherein the two-stage fluid regulator comprises an in-line two-stage fluid regulator.

16. The fluid regulator apparatus of claim 11, wherein the fluid inlet port defines a passageway to vent a portion of the fluid inlet port to atmospheric pressure when the fluid inlet port receives the modular in-line fluid regulator.

17. The fluid regulator apparatus of claim 11, wherein the modular in-line fluid regulator comprises a guide that receives at least a portion of a stem coupled to the pressure sensing member, the guide to at least partially guide movement of the pressure sensing member.

18. A method of field converting a fluid regulator apparatus from a one-stage fluid regulator to a multi-stage fluid regulator, comprising:
removing a coupling associated with one-stage fluid regulation from an inlet port of a fluid regulator, the inlet port being configured to interchangeably receive the coupling or a modular in-line fluid regulator associated with multi-stage fluid regulation; and
inserting the modular in-line fluid regulator into the inlet port to change the fluid regulator apparatus from a one-stage fluid regulator to a multi-stage fluid regulator without substantially changing a size of the fluid regulator.

19. The method of claim 18, wherein inserting the modular in-line fluid regulator into the inlet port comprises coupling the fluid regulator and the modular in-line fluid regulator.

20. The method of claim 18, wherein inserting the modular in-line fluid regulator into the inlet port comprises threadingly engaging the modular in-line fluid regulator with the inlet port.
